(19) United States
(12) Patent Application Publication
(10) Pub. No.: US 2005/0036790 A1
(43) Pub. Date: Feb. 17, 2005

(54) Method and system for optical fiber transmission using Raman amplification

(75) Inventors: Toshiki Tanaka, Kawasaki (JP); Takao Naito, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/943,261

(22) Filed: Sep. 17, 2004

Related U.S. Application Data
(63) Continuation of application No. PCT/JP03/03369, filed on Mar. 19, 2003.

(30) Foreign Application Priority Data
Mar. 19, 2002 (JP) 2002-075462
Jul. 12, 2002 (JP) 2002-204462

(51) Int. Cl. H04B 10/02

(52) U.S. Cl. 398/177

(57) ABSTRACT

A variable optical attenuator for attenuating the signal light is provided in an optical fiber transmission line for transmission of signal light while performing Raman amplification, and the attenuation of the variable optical attenuator is adjusted based on the optical power detected at the reception terminal of the optical fiber transmission line.

### CROSS REFERENCE TO RELATED APPLICATION

This application is a continuation of international PCT application No. PCT/JP03/03369 which was filed on Mar. 19, 2003.

### BACKGROUND OF THE INVENTION

1. Field of the Invention

The present invention relates to a method and a system for optical fiber transmission using Raman amplification.

2. Description of the Related Art

Recently, the low-loss (for example, 0.2 dB/km) production and utilization technologies of quartziferous optical fiber have been developed, and the optical communication system using an optical fiber as a transmission line has become commercially practical. Furthermore, to realize long-distant transmission by compensating for a loss through optical fiber, an optical amplifier for amplifying an optical signal or a signal light has been put to practical use.

What has been conventionally known is an optical amplifier including an optical amplifying medium for receiving a signal light to be amplified, and a pumping unit for pumping an optical amplifying medium so that the optical amplifying medium can provide a gain band containing the wavelength of a signal light.

For example, to amplify a signal light having the wavelength of 1.5 μm with a small loss using a silica based fiber, an erbium doped fiber amplifier (EDFA) has been developed. The EDFA includes an erbium doped fiber (EDF) as an optical amplifying medium and a source of pumping light for providing the EDF with pumping light having a predetermined wavelength. Using the pumping light having a wavelength of a 0.98 μm band or a 1.48 μm band, a gain band containing a wavelength of 1.55 μm can be obtained.

The wavelength division multiplexing (WDM) has been used as a technology of increasing the transmission capacity through optical fiber. In a system to which the WDM is applied, a plurality of optical carriers having different wavelengths are used. A plurality of optical signals obtained by independently modulating each optical carrier are wavelength division multiplexed by an optical multiplexer, and a resultant WDM signal light is transmitted to an optical fiber transmission line. On the receiving side, a received WDM signal light is demultiplexed by an optical demultiplexer into each optical signal, and the transmission data can be regenerated according to each optical signal. Therefore, by applying the WDM, the transmission capacity of one optical fiber can be increased depending on the number of multiplexed signals.

Thus, using the optical amplifier as a linear repeater, the number of parts in the repeater can be considerably reduced, the reliability can be obtained, and the cost can be remarkably reduced as compared with the case in which a conventional regenerative repeater is used.

Recently, instead of the EDFA, a low-noise and broad-band optical repeater using Raman amplification has been widely introduced. In the Raman amplification, the optical fiber commonly used as an optical fiber transmission line bas been used as an optical amplifying medium, and the pumping light is supplied to the optical fiber. As a source of pumping light for use in the Raman amplification, a high powered source is required. Therefore, the high power output and the high efficiency of a recent laser diode (LD) are expected to accelerate the practical use of an optical repeater using the Raman amplification. Additionally, in the remote amplification method of pumping light from the end of an optical fiber transmission line without an optical repeater, the Raman amplification in which common optical fiber is used as an optical amplifying medium is effective in providing a distributed type amplifying system.

As a conventional technology for controlling a Raman amplifier, a device for controlling the output of a Raman amplifier by complicated control of power of each of a plurality of wavelengths has been disclosed.

Nonpatent Literature 1

“Simple gain control method for broadband Raman amplifiers gain-flattened by multi-wavelength pumping”, Y. Emori, et al., Tu. A. 2. 2. ECOC2001, 2001)

When a Raman amplifier using a multi-wavelength pumping light source in an optical fiber transmission system is applied to an optical fiber transmission system to which the WDM is applied, the following points are to be considered.
1. In the Raman amplification, the power (antilogarithm) of the pumping light is substantially proportional to the gain (dB).
2. The interaction arises between the pumping lights. Practically, the pumping light having a relatively long wavelength is amplified by the pumping light having a relatively short wavelength.
3. The variations of the gain depend on the variations of the characteristic of the optical fiber as a transmission line.
4. The output light power of the source of pumping light is restricted.
5. When a transmission line includes an up line and a down line, it is desired that redundancy is allowed to the parts having common functions.
6. The Raman amplifier has low gain saturation as compared with the case of the EDFA. In the case of a long-distance transmission system, it is demanded that the power supply capability of the system, the thermal design of a repeater, the reliability of the LD for pumping, the cost, etc. are to be considered.

Therefore, with the above-mentioned items taken into account, the following problems arise.

To constantly control the optical output in each repeater, it is necessary to perform complicated control on each source of pumping light and insert a device having the function of controlling a variable optical attenuator to a pumping system, thereby requiring a very complicated configuration.

Furthermore, when control is performed to maintain constant power of pumping light, it is easy to control a source of pumping light, but it is difficult to appropriately control the output power by the variations of the Raman gain from the variance of fiber.

Additionally, for example, when redundancy is allowed for the source of pumping light, it is difficult to control each circuit (fiber core cable) only by controlling the pumping light.

### SUMMARY OF THE INVENTION

The present invention aims at providing the method and apparatus for optical transmission capable of easily stabilizing the characteristics when Raman amplification is applied. Other objects of the present invention are apparent from the explanation given below.

The first aspect of the present invention refers to a method including a step of providing an optical fiber transmission line for transmission of signal light through Raman amplification, a step of providing a variable optical attenuator for attenuating the signal light in the optical fiber transmission line, a step of detecting the optical power at the reception terminal of the optical fiber transmission line, and a step of adjusting the attenuation of a variable optical attenuator.

In this method, since the attenuation of the variable optical attenuator provided in the optical fiber transmission line is adjusted based on the detected value of the optical power at the reception terminal of the optical fiber transmission line, various characteristics in the Raman amplification are stabilized, thereby attaining the object of the present invention.

The second aspect of the present invention refers to a system including an optical fiber transmission line for transmitting signal light through Raman amplification, a variable optical attenuator provided in the optical fiber transmission line for attenuating the signal light, a device for detecting the optical power at the reception terminal of the optical fiber transmission line, and a device for adjusting the attenuation of the variable optical attenuator based on the detected optical power.

The third aspect of the present invention refers to a method including a step of providing an optical fiber transmission line for transmission of signal light through Raman amplification, a step of providing a variable optical attenuator for attenuating the signal light in the optical fiber transmission line, a step of detecting the optical power in the optical fiber transmission line, and a step of adjusting the attenuation of a variable optical attenuator.

The fourth aspect of the present invention refers to a system including an optical fiber transmission line for transmitting signal light through Raman amplification, a variable optical attenuator provided in the optical fiber transmission line for attenuating the signal light, a device for detecting the optical power in the optical fiber transmission line, and a device for adjusting the attenuation of the variable optical attenuator based on the detected optical power.

The fifth aspect of the present invention refers to a method including a step of pumping an optical fiber transmission line so that the optical fiber transmission line can perform Raman amplification on signal light, a step of detecting again slope in the Raman amplification, a step of controlling the level of the pumping based on the gain slope.

The sixth aspect of the present invention refers to a system including an optical fiber transmission line for transmission of signal light, a source of pumping light for pumping the optical fiber transmission line such that the optical fiber transmission line can perform Raman amplification on signal light, a device for detecting a gain slope in the Raman amplification, and a device for controlling the source of pumping light according to the gain slope.

### BRIEF DESCRIPTION OF THE DRAWINGS

FIG. 1 is a block diagram of the optical fiber transmission system to which the present invention can be applied;

FIG. 2 is a block diagram showing the first embodiment of the system according to the present invention;

FIG. 3 is a block diagram showing the second embodiment of the system according to the present invention;

FIG. 4 is a block diagram showing the third embodiment of the system according to the present invention;

FIG. 5 is a block diagram showing the fourth embodiment of the system according to the present invention;

FIG. 6 is a block diagram showing the fifth embodiment of the system according to the present invention;

FIG. 7 is a block diagram showing the sixth embodiment of the system according to the present invention;

FIG. 8 is a block diagram showing the seventh embodiment of the system according to the present invention;

FIG. 9 is a block diagram showing the eighth embodiment of the system according to the present invention;

FIG. 10 is a block diagram showing the ninth embodiment of the system according to the present invention;

FIG. 11 is a block diagram showing the tenth embodiment of the system according to the present invention; and

FIG. 12 is a block diagram showing the eleventh embodiment of the system according to the present invention.

### DESCRIPTION OF THE PREFERRED EMBODIMENTS

The embodiments of the present invention are described below in detail by referring to the attached drawings.

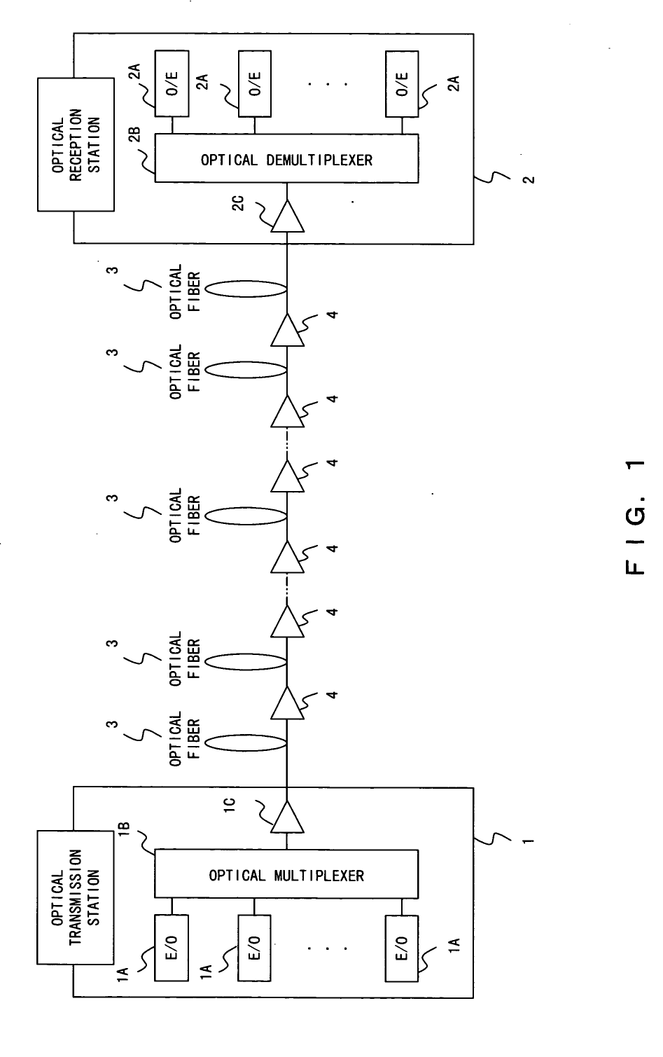

FIG. 1 is a block diagram of the optical fiber transmission system to which the present invention can be applied. The system is configured by providing an optical fiber transmission line 3 between an optical transmission station 1 and an optical reception station 2, and a plurality of units 4 for optical amplification in the optical fiber transmission line 3 to obtain a Raman gain in the optical fiber transmission line 3.

The unit 4 for optical amplification comprises at least a source of pumping light for Raman amplification in the optical fiber transmission line 3 and a wavelength division multiplexing coupler for backpumping the pumping light for the signal light transmitted through the optical fiber transmission line 3. That is, the unit 4 for optical amplification performs pumping for the distributed Raman amplification on the signal light in the optical fiber transmission line 3.

In addition to the above-mentioned configuration, the unit 4 for optical amplification can also be configured such that an optical fiber having a smaller effective core cross-sectional area as compared with a 1.3 μm zero dispersion fiber (single mode fiber) such as a dispersion compensation fiber (DCF), a dispersion shift fiber (DSF), etc. can be provided in or at the terminal of the optical fiber transmission line 3, the fiber having a smaller effective cross-sectional area can be backpumped, and concentrated Raman amplification can be performed.

In addition, the unit 4 for optical amplification can also be configured such that the distributed Raman amplification can be combined with the concentrated Raman amplification with the pumping light propagated in both the optical fiber transmission line 3 and the fiber having a smaller effective core cross-sectional area.

The optical transmission station 1 comprises a plurality of optical transmitters (E/O) 1A for outputting a plurality of optical signals having different wavelengths, an optical multiplexer 1B for obtaining a WDM signal light by wavelength division multiplexing the plurality of optical signals, and a post amplifier 1C for amplifying the obtained WDM signal light to a required level and outputting the resultant light to the optical fiber transmission line 3.

The optical reception station 2 comprises a preamplifier 2C for amplifying the WDM signal light transmitted through the optical fiber transmission line 3 into a required level, an optical demultiplexer 2B for demultiplexing the amplified WDM signal light into a plurality of optical signals depending on the wavelengths, and a plurality of optical receivers (O/E) 2A for receiving the optical signals.

The optical fiber transmission line 3 has a plurality of relay regions for connecting the optical transmission station 1 to the optical reception station 2. The WDM signal light output from the optical transmission station 1 propagates through the optical fiber transmission line 3, and is then amplified by the unit 4 for optical amplification provided at predetermined intervals in the optical fiber transmission line 3, and propagates through the next optical fiber transmission line 3. These processes are repeated and the WDM signal light is transmitted to the optical reception station 2.

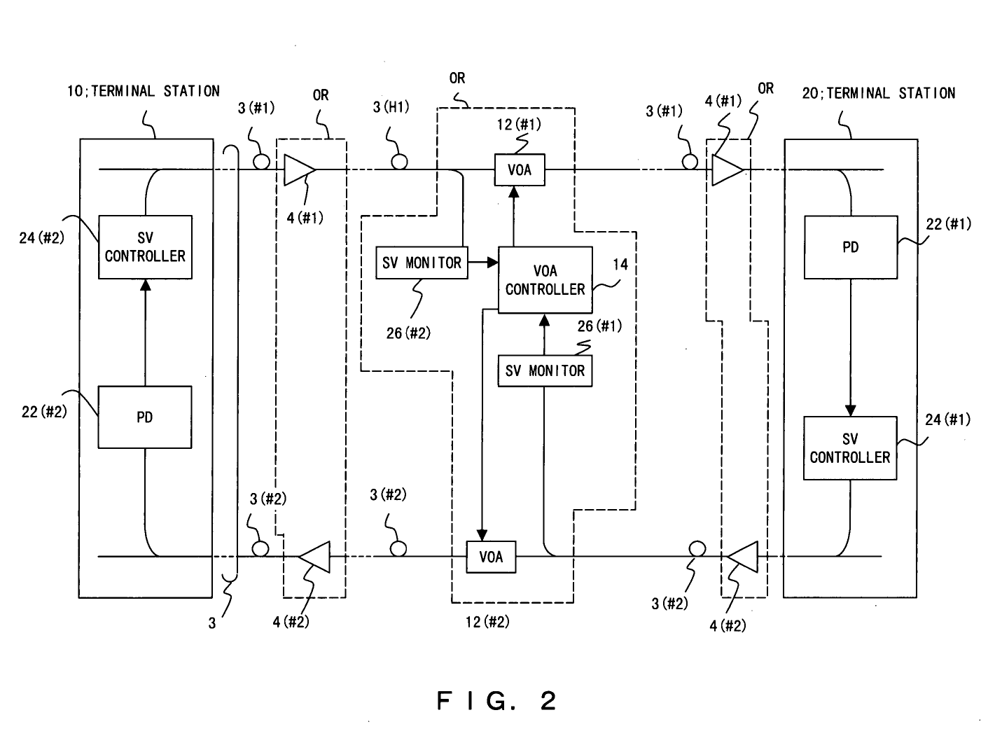

FIG. 2 is a block diagram showing the first embodiment of the system according to the present invention. In FIG. 2, the optical fiber transmission line 3 includes the optical fiber transmission line 3 (#1) as an up line and the optical fiber transmission line 3 (#2) as a down line. Terminal stations 10 and 20 are provided respectively corresponding to the optical transmission station land the optical reception station 2 shown in FIG. 1. Each of the terminal stations 10 and 20 has the function of the optical transmission station and the optical reception station respectively.

In the optical fiber transmission lines 3 (#1 and #2), characteristic variable optical attenuators 12 (#1 and #2) according to the present invention are provided. The attenuation of the variable optical attenuators 12 (#1 and #2) is adjusted by a VOA controller 14.

To detect the optical power at the reception terminal of the optical fiber transmission line 3 (#1), the terminal station 20 includes a photodetector (PD) 22 (#1) as a power monitor. For example, the branched light for monitor is input to the photodetector (PD) 22 (#1) at the upstream or the downstream of the preamplifier 2C shown in FIG. 1.

The terminal station 20 is provided with an SV controller 24 (#1) for receiving a signal of detected value of the optical power detected by the photodetector (PD) 22 (#1). The SV controller 24 (#1) generates a monitor signal containing the data of the detected optical power. The monitor signal is converted into an optical signal, and transmitted by the optical fiber transmission line 3 (#2) as an up line to a control target as practically described below.

In this embodiment, the SV controller 24 (#1) superposes the monitor signal on the WDM signal light by moderately modulating the intensity of the WDM signal light transmitted to the optical fiber transmission line 3 (#2) according to the monitor signal. The monitor signal is received by an SV monitor 26 (#1) branched from the optical fiber transmission line 3 (#2), appropriate data processing is performed on the signal, and the result is provided for the VOA controller 14. The VOA controller 14 controls the variable optical attenuator 12 (#1) such that the optical power detected by the photodetector (PD) 22 (#1) indicates a prescribed value.

In this embodiment, the monitor signal is superposed on the WDM signal light, but light of a wavelength can be newly added to the WDM signal light, and the light can be modulated using the monitor signal. In this case, the SV monitor monitors the light of the new wavelength.

To similarly control the variable optical attenuator 12 (#2) provided in the optical fiber transmission line 3 (#2) as an up line, the photodetector (PD) 22 (#2), the SV controller 24 (#2), and the SV monitor 26 (#2) are provided respectively corresponding to the photodetector (PD) 22 (#1), the SV controller 24 (#1), and the SV monitor 26 (#1).

In this embodiment, the optical repeater OR provided in the optical fiber transmission line 3 (#1) can be either contained in an optical repeater OR as a pair of the unit 4 for optical amplification (#1) and the unit 4 for optical amplification (#2) provided in the optical fiber transmission line 3 (#2) as a down line, or provided with a gain control adjustment device comprising the variable optical attenuators 12 (#1 and #2), the VOA controller 14, and the SV monitors 26 (#1 and #2).

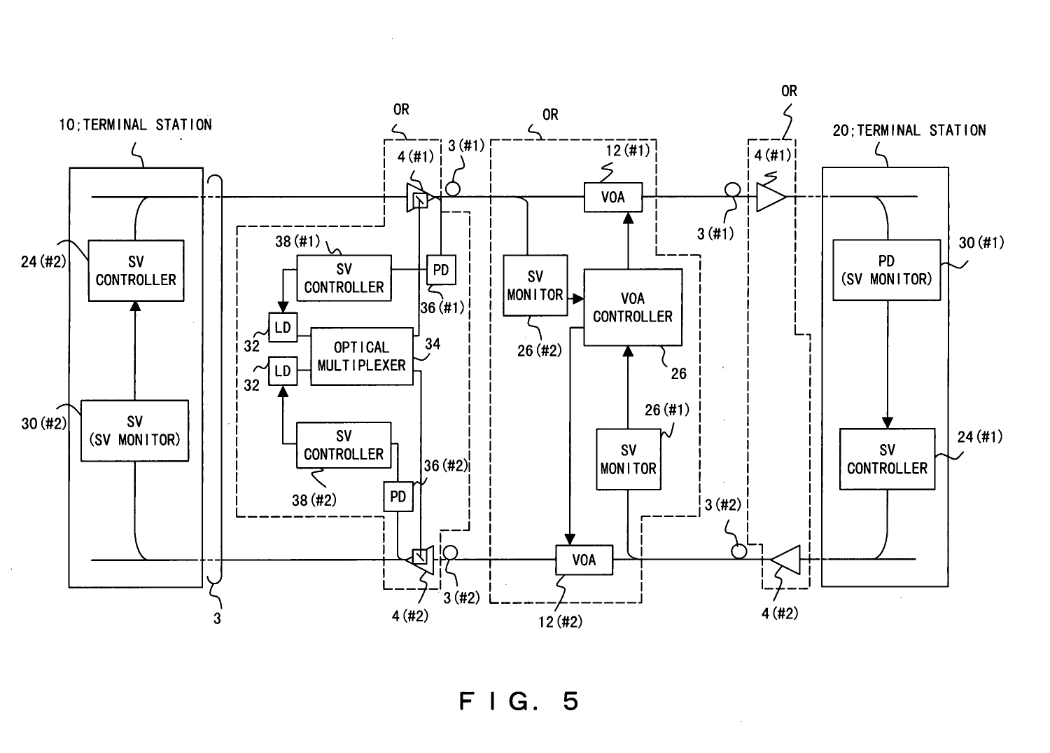

The unit 4 (#1) and the unit 4 (#2) can be independently operated in the optical fiber transmission line 3 (#1) and the optical fiber transmission line 3 (#2) in the optical repeater OR, or as described by referring to another embodiment described later, or can be configured such that, to allow the redundancy relating to the source of pumping light as shown in FIG. 5, for example, the output of two LDs 32 for outputting pumping light having different wavelengths can be provided for an optical multiplexer 34, and the output can be equally divided into two portions and introduced to the optical fiber transmission lines 3 (#1 and #2). In FIG. 2, the LD 32 and the optical multiplexer 34 are included in the units 4 (#1 and #2), and are omitted in the drawings.

Then, the control operation of the system shown in FIG. 2 is described below in detail. The gain obtained from each of the units 4 (#1 and #2) for optical amplification can be adjusted by the output power of the entire LD 32, and the wavelength characteristic of the gain of each of the units 4 (#1 and #2) can be adjusted by the balance of the output of the LD 32. That is, by the gain band arising based on plural (two in this embodiment) pumping lights having different wavelengths in different positions on the wavelength axis, the gain in each gain band is changed by the power of each the pumping lights, thereby changing the wavelength characteristic of the obtained gain.

In this example, the control operations of the variable optical attenuators 12 (#1 and #2) are described below by assuming that the pumping condition of each of the units 4 (#1 and #2) is set to be constant when the system starts its operation. Maintaining a constant pumping condition can be independently performed in each optical repeater.

For example, the loss of the optical fiber transmission lines 3 (#1 and #2) can be increased while using the system for a long period. The increase in the loss is the problem with the optical fiber core, and the value is variable.

In the communications by cable, it is necessary to pull up the cable from the sea and add additional cable when the cable of the transmission line is cut off. This process is referred to as cable reconstruction. If the number of the portions to be amended increases, and the number of reconstructed transmission lines increases, then the lose of the transmission line increases as compared with the initial status. In the present embodiment, the increase in the loss of the optical fiber transmission lines 3 (#1 and #2) is detected by each of the terminal stations 10 and 20, and the change in the loss of the optical fiber transmission lines 3 (#1 and #2), etc. can be compensated for by adjusting the variable optical attenuators 12 (#1 and #2) according to the present invention.

The gain in the Raman amplification is generated at about 100 nm wavelength of the pumping light. Therefore, a substantially flat gain characteristic can be generated in a broad band by adjusting the number of wavelengths of pumping light, the wavelength intervals, and the power.

On the other hand, the variable optical attenuator can vary the amount of attenuation almost independent of the wavelength.

Therefore, the Raman amplification gain is maximized when the system is designed, the attenuation is assigned in the transmission range on the reception side. When the loss in the transmission line increases due to elapsed time and cable reconstruction, the amount of attenuation of the variable optical attenuators 12 (#1 and #2) is controlled to be reduced, thereby stably obtaining target power on the reception side.

With the maximum attenuation assigned to the variable optical attenuator when the system is designed, the Raman amplification gain is assigned such that the transmission can be performed on the reception side. Thus, although the loss increases due to the degradation of the optical fiber transmission line with the lapse of time and the cable reconstruction of the transmission line, the target power can be obtained on the reception side with the amount of attenuation of the variable optical attenuator reduced.

That is, the system of the present invention is configured with the high amount of attenuation of the variable optical attenuator at the initial state, the entire transmission line is adjusted, the amount of attenuation can be controlled to be reduced depending on the loss in the transmission line. Thus, when the pumping light for Raman amplification is controlled for a flat gain, there is no necessity of control of the wavelength intervals, the wavelength, or power although the loss of the optical fiber transmission line becomes large for any reason, thereby simplifying the control of the system.

The present embodiment is effective for a Raman amplifier especially a distributed Raman amplifier for using an optical fiber transmission line as a gain medium in the Raman amplification because the Raman amplifier is low in saturation, and, when the power of the pumping light is constant, the increase in loss substantially equals the reduction of the output of the repeater.

Furthermore, since there is no necessity of large adjustment for the power of the pumping light, the increase in gain deviation is eliminated, and there is no necessity of the complicated control of the power of pumping light, thereby providing a repeater with a simple configuration.

As it is apparent from the above-mentioned embodiment, the up and down circuits can be easily performed independently.

Additionally, the fluctuation in characteristic due to the degradation of a transmission line with the lapse of time can be reduced. For example, with the degradation with the lapse of time taken into account, if the optical power is periodically measured at the terminal station after the construction, and the monitor value does not satisfy the range of a prescribed value, then each variable optical attenuator can be controlled in the above-mentioned method (similar in the embodiment below).

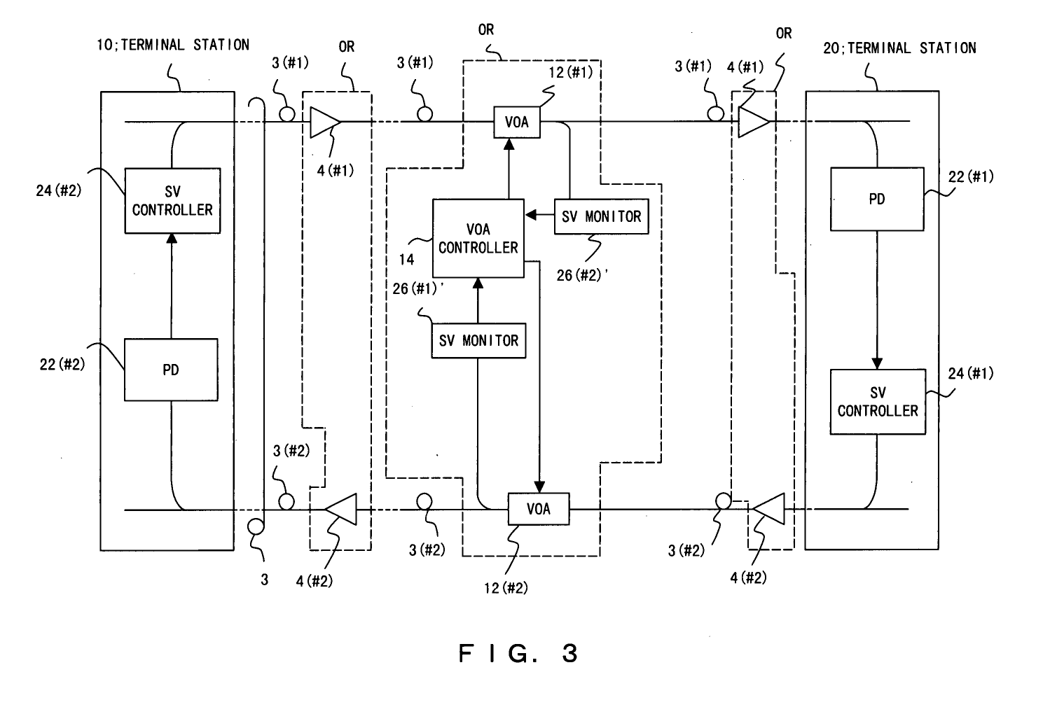

FIG. 3 is a block diagram showing the second embodiment of the system according to the present invention. In FIG. 3, the identical member also shown in FIG. 3 is assigned the same reference numeral and symbol, and the explanation is omitted here.

In FIG. 3, as compared with the embodiment shown in FIG. 2, the SV monitors 26 (#2 and #1)′ are provided in the downstream of the variable optical attenuators 12 (#1 and #2). Thus, when the method according to the present invention is used, the arranging position of the SV monitor can be appropriately changed depending on the level of the signal light.

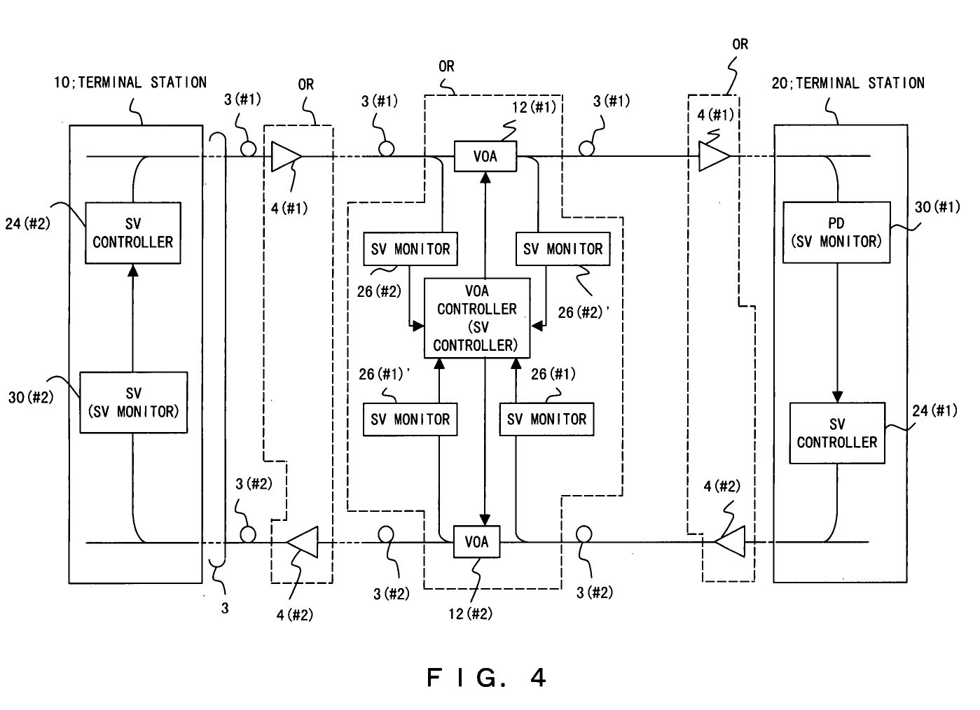

FIG. 4 is a block diagram showing the third embodiment of the system according to the present invention. In this embodiment, the VOA controller 28 having the additional function in comparison with the embodiments shown in FIGS. 2 and 3 is used, and photodetectors 30 (#2 and #1) having the function of the SV monitor is provided as replacing the photodetectors 22 (#2 and #1) (for example, as shown in FIG. 1) provided for the terminal stations 10 and 20. The portion assigned the same reference numeral and symbol similarly functions as in the above-mentioned embodiments, and the explanation is omitted here.

In this embodiment, in the optical fiber transmission line 3 (#1) as a down line, the SV monitors 26 (#2) and 26 (#2)′ are provided respectively for the downstream and the upstream of the variable optical attenuator 12 (#1). Especially, the SV monitor 26 (#2)′ can detect the optical power. Thus, the attenuation of the variable optical attenuator 12 (#1) is practically measured, and the measurement result is provided for a VOA controller 28. The VOA controller 28 modulates the attenuation of the VOA controller 28 according to the signal indicating the measurement value of the provided attenuation, and the measurement value of the attenuation is transmitted to the terminal station 20.

At the terminal station 20, the photodetectors 30 (#1) detects the measurement value of the attenuation of the VOA controller 28, and appropriately amends the SV signal in the SV controller 24 (#1). By amending the SV signal, the control of the attenuation of the variable optical attenuator 12 (#1) can be more correctly performed.

A similar amendment can also be made by transmitting the control current value, etc. without practically measuring the attenuation of the variable optical attenuator 12 (#1).

Since this holds true with the optical fiber transmission line 3 (#2) as an up line, the explanation is omitted here.

FIG. 5 is a block diagram showing the fourth embodiment of the system according to the present invention. FIG. 5 shows the configuration for an additional operation to the operation according to the embodiment shown in FIG. 2.

In the units 4 (#1 and #2) for optical amplification for the up and down lines arranged in one repeater, the output of the two LDs (laser diodes) for outputting pumping light having different wavelengths is provided for the optical multiplexer 34 to allow the redundancy for the source of pumping light, and the output is equally divided into two for use in the units 4 (#1 and #2).

In this embodiment, the optical power in the optical fiber transmission line 3 is measured, and the variable optical attenuators 12 (#1 and #2) can be controlled based on the measurement value. For example, the photodetector 36 (#1) is connected to the branched optical path at the downstream of the unit 4 for optical amplification (#1) for the optical fiber transmission line 3 (#1) so that the optical power can be measured in the transmission line, and the LD 32 as a source of pumping light is modulated based on the measurement result. Therefore, the measurement result of the photodetector 36 (#1) can be obtained at the terminal station 20. Based on the measurement result, a storage medium for control of the variable optical attenuator 12 (#1) can be generated.

A practical controlling operation is described below. The output of the repeater in the optical fiber transmission line 3 (#1) is monitored by the photodetector 36 (#1), and the result is transmitted to the terminal station 20 by the modulation of the pumping light or by the superposition of the monitor control signal. At the terminal station 20, the entire system is recognized relating to the down line, and the fluctuation of the system such as the fluctuation of the attenuation of the optical fiber transmission line 3 (#1), etc. can be adjusted by adjusting the variable optical attenuator 12 (#1) arranged in the block not satisfying the prescribed value according to the control signal. The modulation and the superposition in this embodiment can be controlled in the region of the entire transmission line or the optical repeater such that the gain characteristic cannot arise against the wavelength.

In the conventional technology, when the attenuation of the optical fiber transmission line 3 (#1) changes for each block, the pumping condition of the corresponding optical repeater OR changes, which can incur a change in wavelength characteristic of a gain. In the present embodiment, the attenuation of the variable optical attenuator 12 (#1) is adjusted by performing the above-mentioned control without changing the pumping condition, thereby adjusting the change in the wavelength characteristic of a gain.

The control of a single repeater is described above, and similar control can be performed on a plurality of repeaters. Furthermore, control based on the measurement of optical power at the reception terminal according to the embodiment shown in FIG. 2 can also be performed.

The optical repeater OR having the units 4 (#1 and #2) can be configured to directly provide the source of pumping light from the LD 32 as is without optical division-multiplexing.

Thus, according to the present embodiment, the measurement value of the optical power can be reflected on the control not at the reception terminal but also in the transmission line. Therefore, minute control can be performed when a multiple stage repeater is used.

Since this holds true with the optical fiber transmission line 3 (#2), the explanation is omitted here.

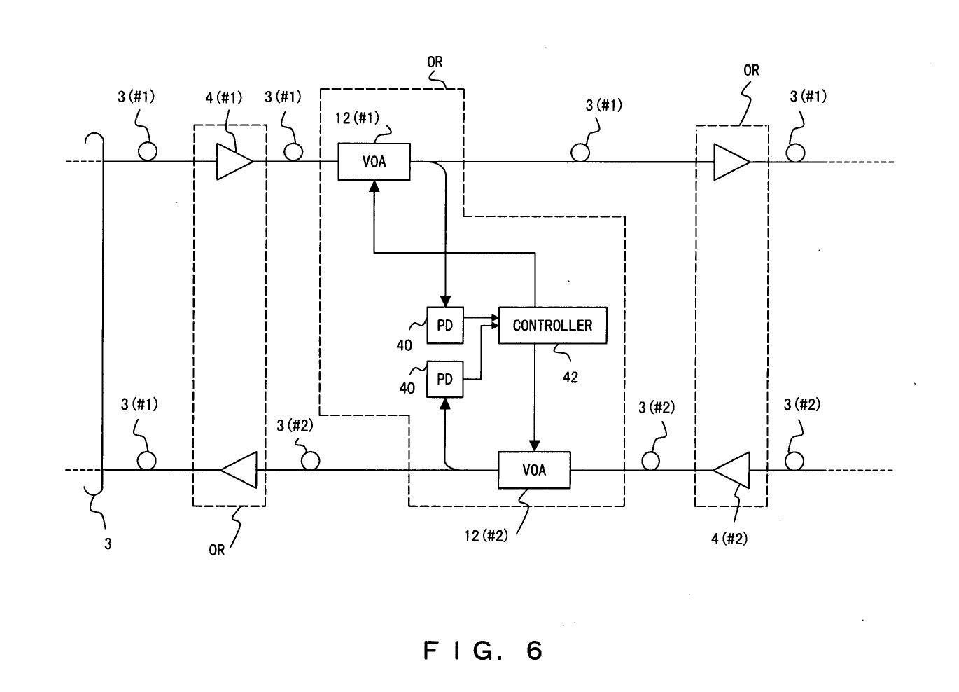

FIG. 6 is a block diagram showing the fifth embodiment of the system according to the present invention.

In FIG. 6, the optical power in the optical fiber transmission lines 3 (#1 and #2) in the up and down lines is detected, and the control of the variable optical attenuators 12 (#1 and #2) is completed in the repeater without the signal processing at the terminal station.

Practically, the optical power in the optical fiber transmission lines 3 (#1 and #2), that is, the output of the variable optical attenuators 12 (#1 and #2) is measured by a photodetector 40 as a power monitor, and a controller 42 controls the variable optical attenuators 12 (#1 and #2) such that the measurement value can be in a predetermined value range. In the example shown in FIG. 6, the photodetector 40 measures the optical power at the downstream of each of the variable optical attenuators 12 (#1 and #2), and the feedback control is performed. However, the optical power can also be measured at the upstream of each of the variable optical attenuators 12 (#1 and #2) and the attenuation can be adjusted in a feed-forward manner.

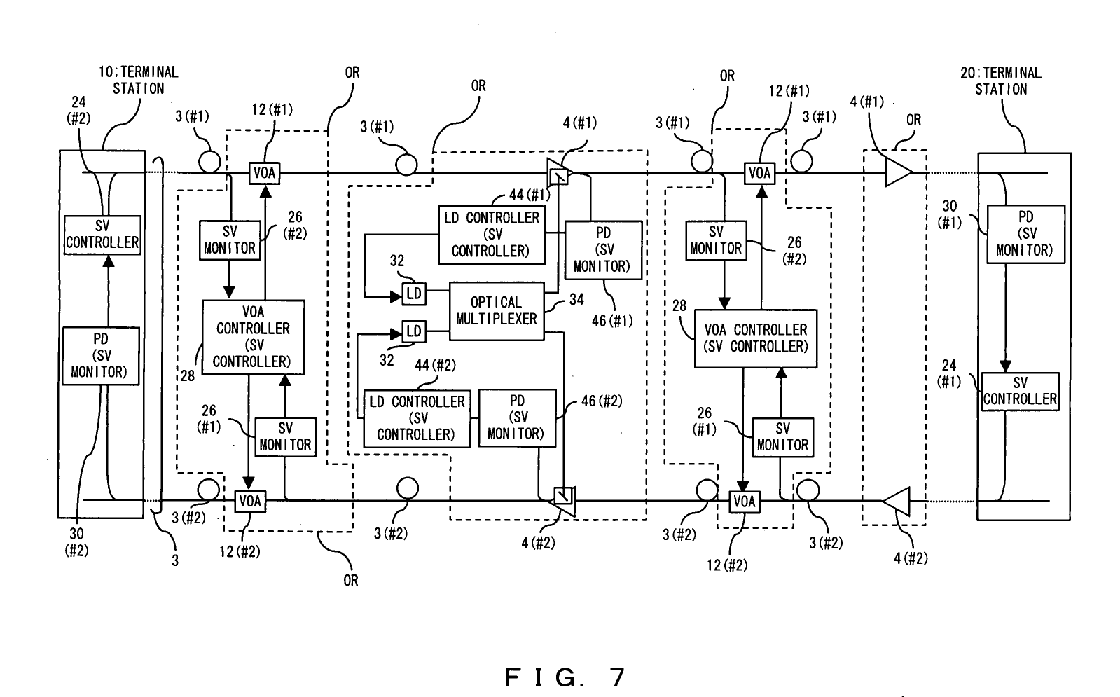

FIG. 7 is a block diagram showing the sixth embodiment of the system according to the present invention. In FIG. 7, the same member as that shown in FIGS. 1 through 6 is assigned the same reference numeral and symbol, and the explanation is omitted here.

In FIG. 7, as compared with the above-mentioned embodiments, not only the attenuation of the variable optical attenuators 12 (#1 and #2), but also the gain in the optical repeater OR including the units 4 (#1 and #2) for optical amplification is controlled, thereby minutely setting the level diagram in the optical fiber transmission line 3. In FIG. 7, the optical repeater OR including the two units 4 (#1 and #2) for optical amplification is shown, and the LD controllers 44 (#1 and #2) are provided to control the pumping condition. The optical repeater OR having the LD controllers 44 (#1 and #2) can be provided in all optical repeaters OR having the units 4 (#1 and #2) for optical amplification, or in a part of the optical repeaters having the units 4 (#1 and #2) for optical amplification in the transmission line, and the units 4 (#1 and #2) for optical amplification of the other optical repeaters can hold the initial settings.

In this embodiment, the SV controllers 38 (#1 and #2) shown in FIG. 5 are replaced with the LD controllers 44 (#1 and #2) functioning as the SV controllers, and the photodetectors 36 (#1 and #2) are replaced with the photodetectors 46 (#1 and #2) functioning as the SV monitors. Furthermore, two sets of the SV monitors 26 (#1 and #2) relating to the control of the variable optical attenuators 12 (#1 and #2) and the VOA controller 28 (shown in FIG. 1) are shown.

As in the embodiment shown in FIG. 4, based on the optical power in the optical fiber transmission lines 3 (#1 and #2) detected by the photodetectors 46 (#1 and #2), the LD controllers 44 (#1 and #2) provide a modulation signal for the LD 32 as a source of pumping light, and the data of the optical power in the optical fiber transmission lines 3 (#1 and #2) is transmitted to the terminal stations 20 and 10.

In this embodiment, the monitor signals from the SV controllers 24 (#1 and #2) respectively provided for the terminal stations 20 and 10 are detected by the photodetectors 46 (#1 and #2) respectively. Based on the detected values, the drive current of the LD as a source of pumping light is adjusted such that the gain in the optical fiber transmission lines 3 (#1 and #2) can be appropriate. Thus, the level diagram in the optical fiber transmission line 3 can be minutely set.

In this embodiment, the gain of the optical amplifier is adjusted based on the detected value of the optical power at the reception terminate of the optical fiber transmission line, but the gain of the optical amplifier can also be adjusted based on the detected value of the optical power in the optical fiber transmission line.

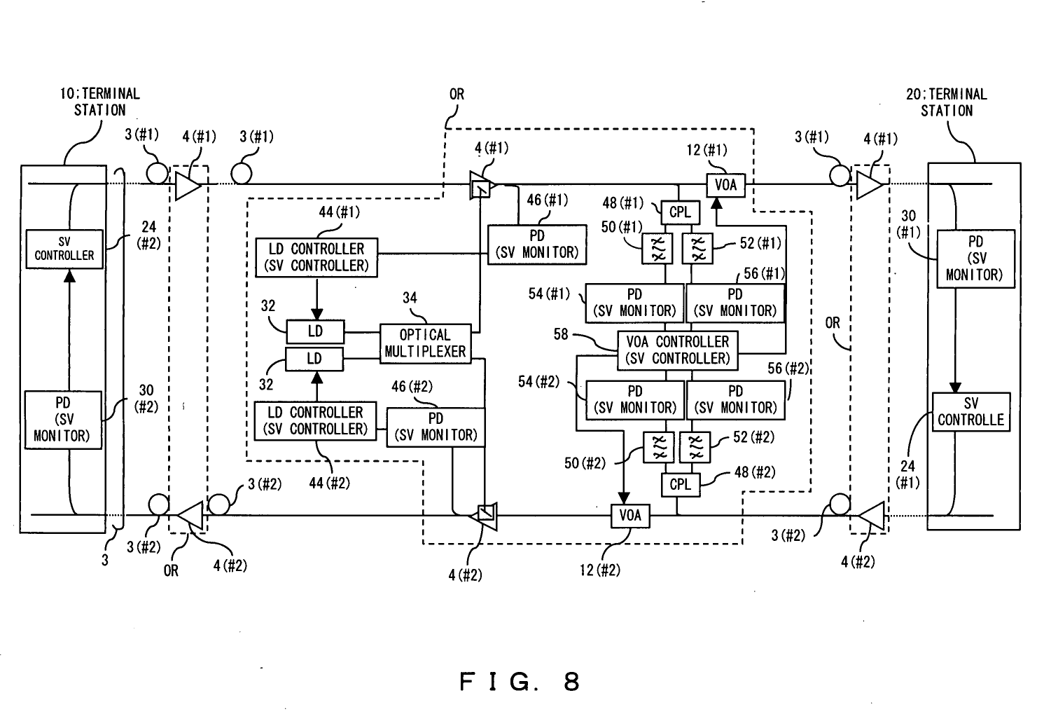

FIG. 8 is a block diagram showing the seventh embodiment of the system according to the present invention. In FIG. 8, the same member as that shown in FIGS. 1 through 7 is assigned the same reference numeral and symbol, and the explanation is omitted here.

In the embodiment shown in FIG. 8, the units 4 (#1 and #2) for optical amplification and the gain control adjustment device mainly comprising the variable optical attenuators 12 (#1 and #2) are accommodated in one optical repeater OR.

The control of the gain of the units 4 (#1 and #2) for optical amplification is the same as in the embodiment shown in FIG. 7. This embodiment is characterized in that when the LD 32 outputs pumping light having different (two in this example) wavelengths the variable optical attenuators 12 (#1 and #2) are controlled based on the optical power (therefore gain) in the Raman amplification band obtained by the respective wavelengths.

Apart of the propagating light in the optical fiber transmission line 3 (#1) as a down line is equally divided into two in power by the optical coupler (CPL) 48, and input to the optical band pass filters (#1 and #2). The optical band pass filters 50 (#1) and 52 (#1) have pass bands contained in the Raman amplification band generated by the unit 4 (#1) using the two sources of pumping light (LD 32). The light from the optical band pass filters (#1 and #2) is provided for the photodetectors 54 (#1) and 56 (#1) respectively, and the output is input to the VOA controller 58 also functioning as an SV controller.

The VOA controller 58 modulates the attenuation of the variable optical attenuator 12 (#1) to transmit the data of the deviation between the photodetectors 54 (#1) and 56 (#1) to the terminal station 20 such that the control for amendment of the power balance of the two sources of pumping light can be performed depending on the deviation.

For example, when the optical power after passing through the filter 50 (#1) is larger than the optical power after passing the filter 52 (#1), the gain deviation can be reduced by reducing the power of the LD 32 corresponding to the filter 50 (#1) and increasing the power of the LD 32 corresponding to the filter 52 (#1) in the repeater block containing the variable optical attenuators 12 (#1 and #2). Furthermore, by compensating by the variable optical attenuator 12 (#1) for the displacement of the average power possibly generated during the adjustment, the variations in the power level diagram of the entire system can be reduced.

When the photodetectors 54 (#1) and 56 (#1) receive a monitor signal when the attenuation of the variable optical attenuator 12 (#1) is adjusted, the reception sensitivity of the monitor signal can be enhanced by the optical band pass filters 50 (#1) and 52 (#1) provided for each Raman amplification band.

Similarly, in the optical fiber transmission line 3 (#2) as an up line, the optical coupler (CPL) 48, the optical band pass filters 50 (#1) and 52 (#1), and the photodetectors 54 (#1) and 56 (#1) are provided, and the explanation of their operations is omitted here.

In the present embodiment, the units 4 (#1 and #2) for optical amplification and the gain control adjustment device mainly comprising the variable optical attenuators 12 (#1 and #2) are accommodated in the same optical repeater OR. However, as shown in FIG. 7, the units 4 (#1 and #2) for optical amplification shown in FIG. 8 and the gain control adjustment device in the configuration shown in FIG. 8 can be accommodated in separate optical repeaters OR.

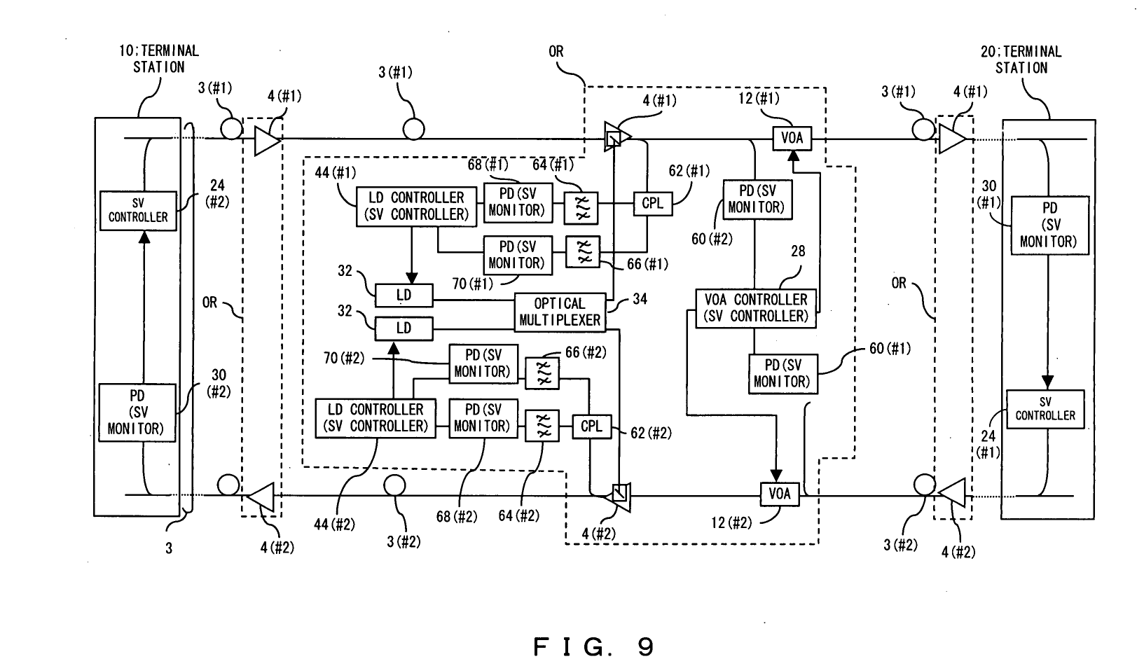

FIG. 9 is a block diagram showing the seventh embodiment of the system according to the present invention. In FIG. 9, the same member as that shown in FIGS. 1 through 8 is assigned the same reference numeral and symbol, and the explanation is omitted here.

In the embodiment shown in FIG. 9, the units 4 (#1 and #2) for optical amplification and the gain control adjustment device mainly comprising the variable optical attenuators 12 (#1 and #2) are accommodated in one optical repeater OR.

When the embodiment shown in FIG. 8 is compared with the embodiment shown in FIG. 9, the gain deviation in the optical band pass filters (#1 and #2) shown in FIG. 8 is detected in association with the variable optical attenuators 12 (#1 and #2) while it is detected in association with the units 4 (#1 and #2) for optical amplification in the embodiment shown in FIG. 9.

Therefore, in this embodiment, the optical coupler (CPL) 62 (#1), the optical band pass filters 64 (#1) and 66 (#1), and the photodetectors 68 (#1) and 70 (#1) are provided respectively corresponding to the optical coupler (CPL) 48 (#1), the optical band pass filters 50 (#1) and 52 (#1), and the photodetectors 54 (#1) and 56 (#1). Similarly, the optical coupler (CPL) 62 (#2), the optical band pass filters 64 (#2) and 66 (#2), and the photodetectors 68 (#2) and 70 (#2) are provided respectively corresponding to the optical coupler (CPL) 48 (#2), the optical band pass filters 50 (#2) and 52 (#2), and the photodetectors 54 (#2) and 56 (#2).

Furthermore, to control the variable optical attenuators 12 (#1 and #2), the SV monitors 26 (#1 and #2) shown in FIG. 7 are respectively replaced with the photodetectors 60 (#1 and #2) also functioning as SV monitors.

For example, when the optical power after the filter 64 (#1) is larger than the optical power after the filter 64 (#2), the LD controller 44 (#1) functions such that the power of the LD 32 corresponding to the filter 64 (#1) becomes smaller and the power of the LD 32 corresponding to the filter 64 (#2) becomes larger, thereby reducing the gain deviation. Furthermore, the displacement of average power possibly generated by the control can be compensated for by the variable optical attenuator 12 (#1), thereby reducing the variations of the power level diagram of the entire system.

The control relating to the optical fiber transmission line 3 (#2) as an up line can similarly be performed.

In this embodiment, since the feedback control can be simply performed on the gain deviation in the units 4 (#1 and #2) for optical amplification, the configuration of the system can be simpler as compared with the control performed by transmitting data of the gain deviation to a terminal station.

In the present embodiment, the units 4 (#1 and #2) for optical amplification and the gain control adjustment device mainly comprising the variable optical attenuators 12 (#1 and #2) are provided in the same optical repeater OR. However, as shown in FIG. 7, the units 4 (#1 and #2) for optical amplification shown in FIG. 9 and the gain control adjustment device in the configuration shown in FIG. 9 can be accommodated in separate optical repeaters OR.

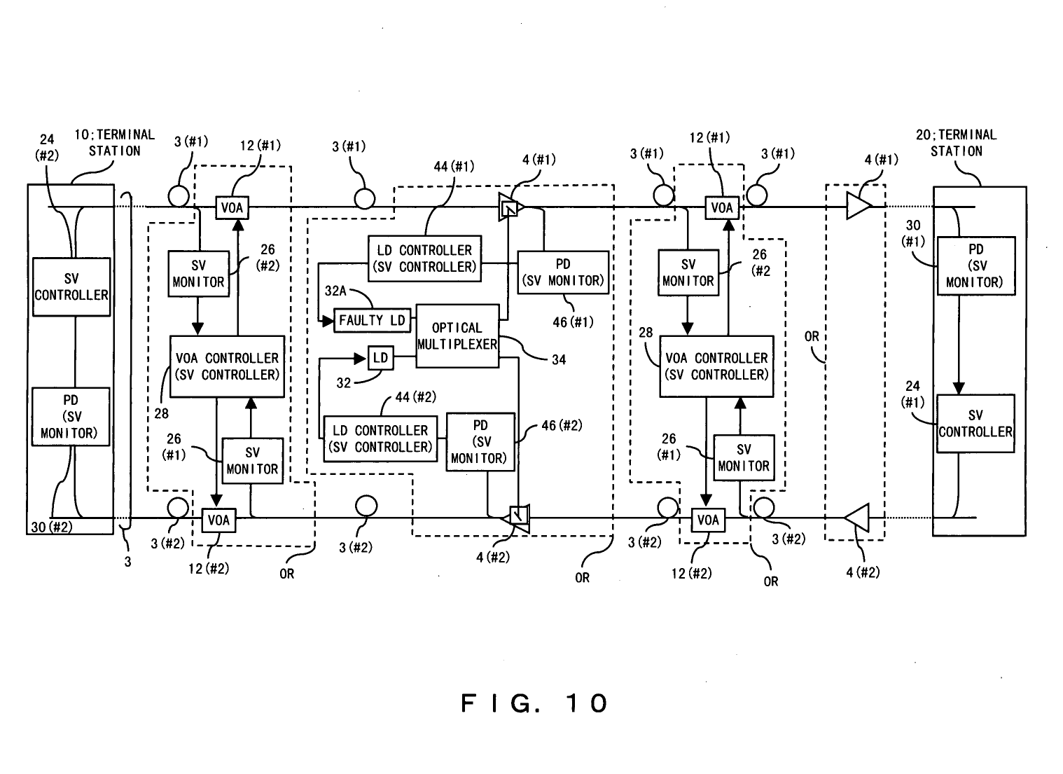

FIG. 10 is a block diagram showing the ninth embodiment of the system according to the present invention. In FIG. 10, in the system as in FIG. 7, one LD 32A in the source of pumping light is faulty.

In FIG. 10, the same member as that shown in FIG. 7 is assigned the same reference numeral and symbol, and the explanation is omitted here.

In FIG. 10, if it is determined that the LD 32A has become faulty from various monitor values, then, for example in a repeater other than the repeater containing the faulty LD 32A, the drive current of the LD outputting the pumping light of the same wavelength is increased. Thus, the influence of the gain of the optical amplifier and the gain deviation changed by the faulty LD 32A can be minimized. Furthermore, the attenuation of the variable optical attenuators 12 (#1 and #2) arranged near the faulty LD 32A can be easily adjusted to maintain the level diagram of the optical power in a prescribed range.

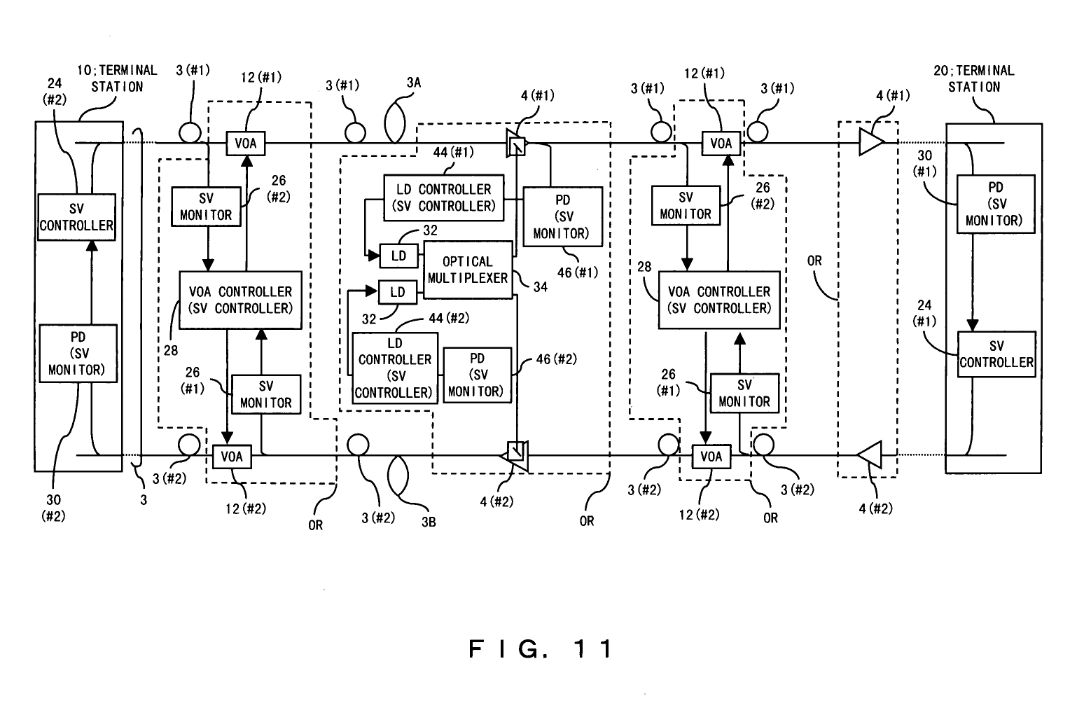

FIG. 11 is a block diagram showing the tenth embodiment of the system according to the present invention.

In this embodiment, in the system as shown in FIG. 7, a cable reconstruction fiber 3A is inserted in the optical fiber transmission line 3. The cable reconstruction fiber 3A is inevitably used in the recovery process for a line disconnection, and it changes the loss in the optical fiber transmission line 3.

In FIG. 11, the same member as that shown in FIG. 7 is assigned the same reference numeral and symbol, and the explanation is omitted here.

In FIG. 10, if it is determined from various monitor values or notification that the cable reconstruction fiber 3A has been inserted, then, for example the drive current of the source of pumping light is increased in the repeater near the cable reconstruction fiber 3A. Thus, the influence of the gain of the optical amplifier and the gain deviation changed by the insertion of the LD 32A can be minimized. Furthermore, the attenuation of the variable optical attenuators 12 (#1 and #2) arranged near the LD 32A can be easily adjusted to maintain the level diagram of the optical power in a prescribed range.

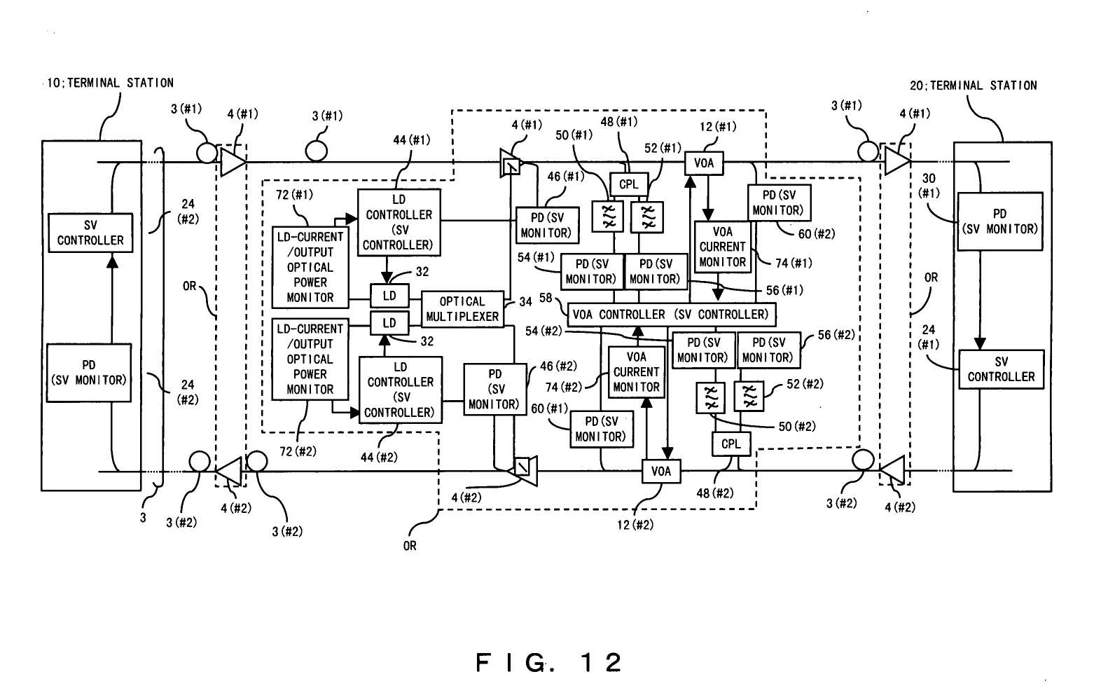

FIG. 12 is a block diagram showing the eleventh embodiment of the system according to the present invention.

In the embodiment shown in FIG. 12, the units 4 (#1 and #2) for optical amplification and the gain control adjustment device mainly comprising the variable optical attenuators 12 (#1 and #2) are accommodated in one optical repeater OR.

In FIG. 12, various functions are added to the embodiment shown in FIG. 8. Practically, the VOA current monitors 74 (#1 and #2) are provided for monitoring the control current of the variable optical attenuators 12 (#1 and #2) respectively. The output of the VOA current monitors 74 (#1 and #2) is provided for the VOA controller 58.

Furthermore, for monitoring the LD 32 as a source of pumping light, the LD current/output optical power monitors 72 (#1 and #2) for measuring the drive current of the LD 32 and the output power are provided. The output of the LD current/output optical power monitors 72 (#1 and #2) is provided for the LD controllers 44 (#1 and #2) respectively.

To perform additional control, the photodetectors 60 (#1 and #2) shown in FIG. 9 are provided. The output of the photodetectors 60 (#1 and #2) is provided for the VOA controller 58.

In this embodiment, the monitor signal and the control can be corrected based on the status of the source of pumping light in the optical amplifier and the measurement value of the drive current of the variable optical attenuator, etc., thereby performing control more correctly.

In the above-mentioned embodiments, monitor control is performed by modulating pumping light, but monitor control by the superposition of a monitor signal on the main signal and other monitor control can be performed.

In the present embodiment, units 4 (#1 and #2) for optical amplification and the gain control adjustment device mainly comprising the variable optical attenuators 12 (#1 and #2) are provided in the same optical repeater OR. However, as shown in FIG. 7, the units 4 (#1 and #2) for optical amplification shown in FIG. 12 and the gain control adjustment device shown in FIG. 12 can be accommodated in separate optical repeaters OR.

In the embodiments shown in FIGS. 2, 3, 4, 5, 6, 7, 10, and 11, the units 4 (#1 and #2) for optical amplification and the gain control adjustment device mainly comprising the variable optical attenuators 12 (#1 and #2) are provided in different optical repeaters OR. However, as shown in FIGS. 8, 9, and 12, the units 4 (#1 and #2) for optical amplification and the gain control adjustment device can be accommodated in the same optical repeater OR.

As described above, according to the present invention, the method and apparatus for optical transmission capable of easily stabilizing the characteristic when Raman amplification is applied can be provided. The effects obtained by the desired embodiments of the present invention are explained above.

1. A method, comprising:
a step of providing an optical fiber transmission line for transmission of signal light through Raman amplification;
a step of providing a variable optical attenuator for attenuating the signal light in the optical fiber transmission line;
a step of detecting optical power at the reception terminal of the optical fiber transmission line; and
a step of adjusting attenuation of the variable optical attenuator.

2. The method according to claim 1, further comprising:
a step of providing an optical repeater including the variable optical attenuator, wherein
said adjusting step comprises a step of generating a monitor signal including data of the detected optical power, and a step of transmitting the monitor signal to the optical repeater.

3. The method according to claim 2, wherein
said optical fiber transmission line is a down line;
said method further comprises a step of providing an optical fiber transmission line as an up line; and
said step of transmitting the monitor signal comprises a step of transmitting an optical signal following the monitor signal through the up line of the optical fiber.

4. The method according to claim 3, wherein
said optical signal following the monitor signal is up signal light modulated by the monitor signal.

5. The method according to claim 1, further comprising:
a step of measuring attenuation of the variable optical attenuator;
a step of transmitting the measured attenuation to a reception terminal of the optical fiber transmission line; and
a step of correcting the monitor signal based on the measured attenuation.

6. A system, comprising:
an optical fiber transmission line for transmitting signal light through Raman amplification;
a variable optical attenuator provided in the optical fiber transmission line for attenuating the signal light;
a device detecting optical power at a reception terminal of the optical fiber transmission line; and
a device adjusting attenuation of the variable optical attenuator based on the detected optical power.

7. The system according to claim 6, wherein
said variable optical attenuator is included in an optical repeater provided in the optical fiber transmission line;
said adjusting device comprises a device of generating a monitor signal including data of the detected optical power, and a device of transmitting the monitor signal to the optical repeater.

8. The system according to claim 7, wherein
said optical fiber transmission line is a down line;
said system further comprises an optical fiber transmission line as an up line; and
said device transmitting the monitor signal comprises a device for transmitting an optical signal following the monitor signal through the up line of the optical fiber.

9. The system according to claim 8, wherein
said optical signal following the monitor signal is up signal light modulated by the monitor signal.

10. The system according to claim 6, further comprising:
a device measuring attenuation of the variable optical attenuator;
a device transmitting the measured attenuation to a reception terminal of the optical fiber transmission line; and
a device correcting the monitor signal based on the measured attenuation.

11. A method, comprising:
a step of providing an optical fiber transmission line for transmission of signal light through Raman amplification;
a step of providing a variable optical attenuator for attenuating the signal light in the optical fiber transmission line;
a step of detecting optical power in the optical fiber transmission line; and
a step of adjusting attenuation of the variable optical attenuator.

12. The method according to claim 11, further comprising:
a step of generating a first monitor signal including data of the detected optical power;
a step of transmitting the first monitor signal to a reception terminal of the optical fiber transmission line;
a step of determining a target value of attenuation of the variable optical attenuator according to the transmitted first monitor signal;
a step of generating a second monitor signal including data of the target value; and
a step of transmitting the second monitor signal to the variable optical attenuator.

13. The method according to claim 12, wherein
said optical fiber transmission line is a down line;
said method further comprises a step of providing an optical fiber transmission line as an up line; and
said step of transmitting the first and second monitor signals comprises a step of transmitting an optical signal following the first and second monitor signals through the down line and the up line of the optical fiber.

14. The method according to claim 13, wherein
said optical signal following the first monitor signal is down signal light modulated according to the first monitor signal; and
said optical signal following the second monitor signal is up signal light modulated according to the second monitor signal.

15. The method according to claim 11, further comprising:
a step of measuring attenuation of the variable optical attenuator;
a step of transmitting the measured attenuation to a reception terminal of the optical fiber transmission line; and
a step of correcting the monitor signal based on the measured attenuation.

16. A system, comprising:
an optical fiber transmission line for transmitting signal light through Raman amplification;
a variable optical attenuator provided in the optical fiber transmission line for attenuating the signal light;
a device detecting optical power in the optical fiber transmission line; and
a device adjusting attenuation of the variable optical attenuator based on the detected optical power.

17. The system according to claim 16, further comprising:
a device generating a first monitor signal including data of the detected optical power;
a device transmitting the first monitor signal to a reception terminal of the optical fiber transmission line;
a device determining a target value of attenuation of the variable optical attenuator according to the transmitted first monitor signal;
a device generating a second monitor signal including data of the target value; and
a device transmitting the second monitor signal to the variable optical attenuator.

18. The system according to claim 17, wherein
said optical fiber transmission line is a down line;
said system further comprises an optical fiber transmission line as an up line; and
said device transmitting the first and second monitor signals comprises a device transmitting an optical signal following the first and second monitor signals through the down line and the up line of the optical fiber.

19. The system according to claim 18, wherein
said optical signal following the first monitor signal is down signal light modulated according to the first monitor signal; and
said optical signal following the second monitor signal is up signal light modulated according to the second monitor signal.

20. The method according to claim 11, further comprising:
a device measuring attenuation of the variable optical attenuator;
a device transmitting the measured attenuation to a reception terminal of the optical fiber transmission line; and
a device correcting the monitor signal based on the measured attenuation.

21. A method, comprising:
a step of pumping an optical fiber transmission line such that the optical fiber transmission line can perform Raman amplification on signal light;
a step of detecting a gain slope in the Raman amplification; and
a step of controlling a level of the pumping based on the gain slope.

22. The method according to claim 21, wherein
said controlling step controls a level of the pumping such that the gain slope can be constant.

23. A system, comprising:
an optical fiber transmission line transmitting signal light;
a source of pumping light for pumping said optical fiber transmission line such that said optical fiber transmission line can perform Raman amplification on signal light;
a device detecting a gain slope in the Raman amplification; and
a device controlling the pumping based on the gain slope.

24. The system according to claim 23, wherein
said source of pumping light comprises two laser diodes for outputting pumping light having different wavelengths;
said device detecting the gain slope comprises: first and second optical band pass filters having pass bands included in an amplification band by the two laser diodes; and a device detecting power of light passing through the first and second optical band pass filters.
